(19) United States
(12) Patent Application Publication
(10) Pub. No.: US 2013/0082974 A1
(43) Pub. Date: Apr. 4, 2013

(54) Quick Access User Interface

(71) Applicants: Duncan Robert Kerr, San Francisco, CA (US); Nicholas V. King, San Jose, CA (US)

(72) Inventors: Duncan Robert Kerr, San Francisco, CA (US); Nicholas V. King, San Jose, CA (US)

(73) Assignee: APPLE INC., Cupertino, CA (US)

(21) Appl. No.: 13/251,126

(22) Filed: Sep. 30, 2011

(51) Int. Cl. G06F 3/045; G06F 3/041

(52) U.S. Cl. 345/174; 345/173

(57) ABSTRACT

Providing quick access to certain applications on a computing device is disclosed. A security wall is enforced with respect to applications on the computer, wherein enforcing the security wall includes preventing access to the applications until a security input is received. A predefined input is received through a home button on a touch-sensitive display of the computer. Access is provided to a particular application in response to receiving the predefined input, wherein providing access to the particular application includes allowing a user to access the particular application without receiving the security input from the user.

### TECHNICAL FIELD

This disclosure relates generally to providing quick access to applications on a computing device.

### BACKGROUND

Computing devices often implement security measures to prevent unwanted or accidental access to applications, features, or information provided by the computing devices. Computing devices frequently store sensitive information that a user may not want other users to view. Users may also generally want to restrict access to their computing devices by other users as a matter of personal preference. Example security measures implemented on computing devices to prevent unwanted access include enforcing a security wall to prevent access to applications on the computing device unless a particular security input is received. Typically, a security code, password, or particular sequence of other inputs is required as a security input to access applications on a computing device when a security wall is implemented on the device.

Although enforcement of the security wall restricts unwanted access to applications on a computing device, the security wall also prevents the owner of the computing device from easily accessing applications on the computing device. In some instances, the user attempting to access the computing device is the owner of the computing device or an authorized user. Further, some applications on the computing device may be associated with private information while other applications have little or no private aspect.

### SUMMARY

In a first general aspect, a method for providing quick access to applications on a computing device is disclosed. A security wall is enforced with respect to applications on the computer, wherein enforcing the security wall includes preventing access to the applications until a security input is received. A predefined input is received through a home button on a touch-sensitive display of the computer. Access is provided to a particular application in response to receiving the predefined input, wherein providing access to the particular application includes allowing a user to access the particular application without receiving the security input from the user.

Implementations can include any or all of the following features. The home button includes a portion of the touch-sensitive display having both touch-sensitive and pressure-sensitive properties. The method further comprises receiving a second instance of the predefined input through the home button and providing access to a second application concurrently with providing access to the particular application, wherein providing access to the second application includes allowing a user to access the second application without receiving the security input from the user. The predefined input includes a first upward motion of a user in contact with the home button and a second upward motion of the user in contact with the home button within a particular amount of time. Providing access to the particular application includes generating for display a visual object representing the particular application on the touch-sensitive display, wherein the visual object is displayed concurrently with a second visual object for bypassing the security wall. Providing access to the particular application includes allowing the user to access a first portion of the particular application while the security wall is enforced with respect to a remaining portion of the particular application.

The particular application includes at least one of a camera application, a remote controller for multimedia player application, a calculator application, a media player application, or a voice control application. The method further comprises receiving a second predefined input through the home button and presenting a login page for traversing the security wall. Enforcing the security wall occurs after the computer has concluded a full boot sequence. The method further comprises automatically waking the computer from a sleep mode in response to receiving the predefined input.

In a second general aspect, a computer program product is tangibly embodied in a computer-readable storage medium and includes instructions that, when executed, enforce a security wall with respect to applications on the computer, wherein enforcing the security wall includes preventing access to the applications until a security input is received. A predefined input is received through a home button on the computer having multi-touch sensitivity. Access is provided to a particular application in response to receiving the predefined input, wherein providing access to the particular application includes allowing a user to access the particular application without receiving the security input from the user.

Implementations can include any or all of the following features. The home button includes a region of a touch screen of the computer having multi-touch sensitivity, the region of the touch screen separate from a touch-sensitive display of the computer. Providing access to the particular application includes generating for display a visual object representing the particular application on the touch-sensitive display and hiding a second visual object for bypassing the security wall. Providing access to the particular application includes allowing the user to access a first portion of the particular application while the security wall is enforced with respect to a remaining portion of the particular application. The particular application includes at least one of a camera application, a remote controller for multimedia player application, a calculator application, a media player application, or a voice control application. The operations further include automatically waking the computer from a sleep mode in response to receiving the predefined input.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example mobile device.

FIG. 2 is a block diagram of an example network operating environment for the mobile device of FIG. 1.

FIGS. 3A-3B are block diagrams of an example implementation of the mobile device of FIG. 1 with a security wall in standby mode.

FIGS. 4A-4B are block diagrams of an example implementation of the mobile device of FIG. 1 in a quick access mode.

FIGS. 5A-5B are block diagrams of an example implementation of the mobile device of FIG. 1 in a quick access mode.

FIGS. 6A-6C are block diagrams of an example implementation of the mobile device of FIG. 1 in a quick access mode.

FIG. 7 is a block diagram of an example implementation of the mobile device of FIG. 1 in a quick access mode.

FIG. 8 is a flow diagram illustrating an example process for providing quick access to applications on a computing device.

FIG. 9 is a block diagram of exemplary hardware architecture for implementing the user interfaces and processes described in reference to FIGS. 1-8.

Like reference numbers and designations in the various drawings indicate like elements.

### DETAILED DESCRIPTION

A computing device can implement a security wall to prohibit unwanted users from accessing functionality provided by the computing device. Instead of applying the security wall to all functionality of the computing device, the computing device can allow user access to functionality when a specific input is received at the computing device. Accordingly, a security input that is normally required to bypass the security wall is not required for access to certain applications on the computing device. The applications that do not require the usual security input may be grouped and presented in a cluster of visual objects in response to a specific input from a user.

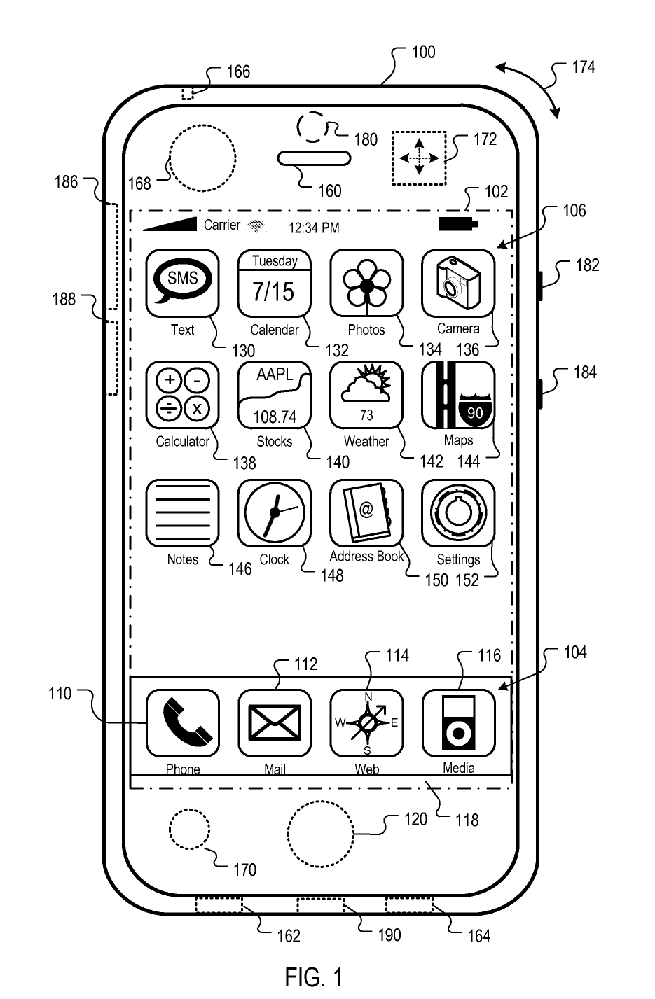

FIG. 1 is a block diagram of an example mobile device 100. The mobile device 100 can be, for example, a handheld computer, a personal digital assistant, a cellular telephone, a network appliance, a camera, a smart phone, an enhanced general packet radio service (EGPRS) mobile phone, a network base station, a media player, a navigation device, an email device, a game console, or other electronic device or a combination of any two or more of these data processing devices or other data processing devices. Although the description below refers generally to mobile device 100, any computing device, including a personal computer, laptop, or tablet, may be used in accordance with the features described in the present disclosure.

### Mobile Device Overview

In some implementations, the mobile device 100 includes a touch-sensitive display 102. The touch-sensitive display 102 can implement liquid crystal display (LCD) technology, light emitting polymer display (LPD) technology, or some other display technology. The touch-sensitive display 102 can be sensitive to haptic and/or tactile contact with a user.

In some implementations, the touch-sensitive display 102 can comprise a multi-touch-sensitive display 102. A multi-touch-sensitive display 102 can, for example, process multiple simultaneous touch points, including processing data related to the pressure, degree and/or position of each touch point. Such processing facilitates gestures and interactions with multiple fingers, chording, and other interactions. Other touch-sensitive display technologies can also be used, e.g., a display in which contact is made using a stylus or other pointing device. An example of a multi-touch-sensitive display technology is described in U.S. Pat. Nos. 6,323,846; 6,570,557; 6,677,932; and U.S. Patent Publication No. 2002/0015024A1, each of which is incorporated by reference herein in its entirety.

In some implementations, the mobile device 100 can display one or more graphical user interfaces on the touch-sensitive display 102 for providing the user access to various system objects and for conveying information to the user. In some implementations, the graphical user interface can include one or more display objects 104, 106. Each of the display objects 104, 106 can be a graphic representation of a system object. Some examples of system objects include device functions, applications, windows, files, alerts, events, or other identifiable system objects.

### Example Mobile Device Functionality

In some implementations, the mobile device 100 can implement multiple device functionalities, such as a telephony device, as indicated by a phone object 110; an e-mail device, as indicated by the e-mail object 112; a network data communication device, as indicated by the Web object 114; a Wi-Fi base station device (not shown); and a media processing device, as indicated by the media player object 116. In some implementations, particular device objects 104, e.g., the phone object 110, the e-mail object 112, the Web object 114, and the media player object 116, can be displayed in a menu bar 118. In some implementations, each of the device functionalities can be accessed from a top-level graphical user interface, such as the graphical user interface illustrated in FIG. 1. The objects 110, 112, 114 and 116 represent visual indicators of applications on the mobile device 100. Touching one of the objects 110, 112, 114 or 116 can, for example, invoke the corresponding functionality.

In some implementations, the mobile device 100 can implement network distribution functionality. For example, the functionality can enable the user to take the mobile device 100 and its associated network while traveling. In particular, the mobile device 100 can extend Internet access (e.g., via Wi-Fi) to other wireless devices in the vicinity. For example, mobile device 100 can be configured as a base station for one or more devices. As such, mobile device 100 can grant or deny network access to other wireless devices.

In some implementations, upon invocation of particular device functionality, the graphical user interface of the mobile device 100 changes, or is augmented or replaced with another user interface or user interface elements, to facilitate user access to particular functions associated with the corresponding device functionality. For example, in response to a user touching the phone object 110, the graphical user interface of the touch-sensitive display 102 may present display objects related to various phone functions; likewise, touching of the email object 112 may cause the graphical user interface to present display objects related to various email functions; touching the Web object 114 may cause the graphical user interface to present display objects related to various Web-surfing functions; and touching the media player object 116 may cause the graphical user interface to present display objects related to various media processing functions.

In some implementations, the top-level graphical user interface environment or state of FIG. 1 can be restored by pressing a home button 120 located near the bottom of the mobile device 100. The home button 120 may be a hardware tactile button that can be depressed physically such that the home button 120 undergoes motion without moving the surrounding region or touch-sensitive display 102. In some implementations, the home button 120 may include multi-touch capabilities similar to the multi-touch-sensitive display 102. Alternatively, the home button 120 may be a “virtual” button that is built into a screen of the mobile device 100, such as immediately below the touch-sensitive display 102. Further, in some implementations, the touch-sensitive display 102 may extend to the bottom of the mobile device 100 to encompass the home button 120 so that a specific region of the touch-sensitive display 102 comprises the home button 120. A user's contact with the specific region may trigger various responses in the mobile device 100 depending on the motion or amount of pressure of the contact. A home button 120 with multi-touch capabilities may process multiple simultaneous touch points, including processing data related to the pressure, degree and/or position of each touch point. Such processing may facilitate gestures and interactions with multiple fingers, chording, and other interactions or touch-sensitive display technologies. In some instances, the region of the touch-sensitive display 102 comprising the virtual home button 120 may provide a certain level of feedback or resistance to simulate a physical tactile button. The virtual home button 120 may not be visible, but in certain implementations, a visual indicator may highlight the region comprising the home button 120, such as a lighted area of the touch-sensitive display 102 within the vicinity of the home button 120. In some implementations, each corresponding device functionality may have corresponding “home” display objects displayed on the touch-sensitive display 102, and the graphical user interface environment of FIG. 1 can be restored by pressing the “home” display object.

In some implementations, the top-level graphical user interface can include additional display objects 106, such as a short messaging service (SMS) object 130, a calendar object 132, a photos object 134, a camera object 136, a calculator object 138, a stocks object 140, a weather object 142, a maps object 144, a notes object 146, a clock object 148, an address book object 150, and a settings object 152. Touching the SMS display object 130 can, for example, invoke an SMS messaging environment and supporting functionality. Likewise, each selection of a display object 132, 134, 136, 138, 140, 142, 144, 146, 148, 150 and 152 can invoke a corresponding object environment and functionality.

Additional and/or different display objects can also be displayed in the graphical user interface of FIG. 1. For example, if the device 100 is functioning as a base station for other devices, one or more “connection” objects may appear in the graphical user interface to indicate the connection. In some implementations, the display objects 106 can be configured by a user, e.g., a user may specify which display objects 106 are displayed, and/or may download additional applications or other software that provides other functionalities and corresponding display objects.

In some implementations, the mobile device 100 can include one or more input/output (I/O) devices and/or sensor devices. For example, a speaker 160 and a microphone 162 can be included to facilitate voice-enabled functionalities, such as phone and voice mail functions. In some implementations, a loud speaker 164 can be included to facilitate hands-free voice functionalities, such as speaker phone functions. An audio jack 166 can also be included for use of headphones and/or a microphone.

In some implementations, a proximity sensor 168 can be included to facilitate the detection of the user positioning the mobile device 100 proximate to the user's ear and, in response, to disengage the touch-sensitive display 102 to prevent accidental function invocations. In some implementations, the touch-sensitive display 102 can be turned off to conserve additional power when the mobile device 100 is proximate to the user's ear.

Other sensors can also be used. For example, in some implementations, an ambient light sensor 170 can be utilized to facilitate adjusting the brightness of the touch-sensitive display 102. In some implementations, an accelerometer 172 can be utilized to detect movement of the mobile device 100, as indicated by the directional arrow 174. Accordingly, display objects and/or media can be presented according to a detected orientation, e.g., portrait or landscape. In some implementations, the mobile device 100 may include circuitry and sensors for supporting a location determining capability, such as that provided by the global positioning system (GPS) or other positioning system (e.g., systems using Wi-Fi access points, television signals, cellular grids, Uniform Resource Locators (URLs)). In some implementations, a positioning system (e.g., a GPS receiver) can be integrated into the mobile device 100 or provided as a separate device that can be coupled to the mobile device 100 through an interface (e.g., port device 190) to provide access to location-based services.

The mobile device 100 can also include a camera lens and sensor 180. In some implementations, the camera lens and sensor 180 can be located on the back surface of the mobile device 100. The camera can capture still images and/or video.

The mobile device 100 can also include one or more wireless communication subsystems, such as a 802.11b/g communication device 186, and/or a Bluetooth™ communication device 188. Other communication protocols can also be supported, including other 802.x communication protocols (e.g., WiMax, Wi-Fi), code division multiple access (CDMA), global system for mobile communications (GSM), Enhanced Data GSM Environment (EDGE), 3G (e.g., EV-DO, UMTS, HSDPA), etc.

In some implementations, a port device 190, e.g., a Universal Serial Bus (USB) port, or a docking port, or some other wired port connection, can be included. The port device 190 can, for example, be utilized to establish a wired connection to other computing devices, such as other communication devices 100, a personal computer, a printer, or other processing devices capable of receiving and/or transmitting data. In some implementations, the port device 190 allows the mobile device 100 to synchronize with a host device using one or more protocols.

### Network Operating Environment

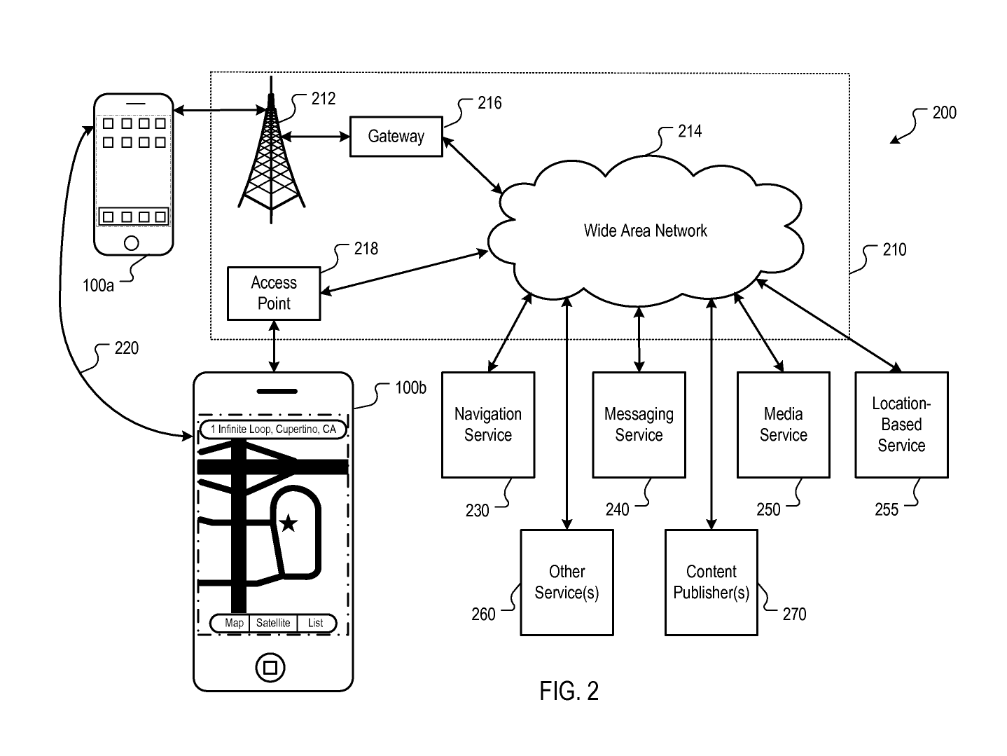

FIG. 2 is a block diagram of an example network operating environment 200 for the mobile device 100 of FIG. 1. The mobile device 100 of FIG. 1 can, for example, communicate over one or more wired and/or wireless networks 210 in data communication. For example, a wireless network 212, e.g., a cellular network, can communicate with a wide area network (WAN) 214, such as the Internet, by use of a gateway 216. Likewise, an access point 218, such as an 802.11g wireless access point, can provide communication access to the wide area network 214. In some implementations, both voice and data communications can be established over the wireless network 212 and the access point 218. For example, the mobile device 100a can place and receive phone calls (e.g., using VoIP protocols), send and receive email messages (e.g., using POP3 protocol), and retrieve electronic documents and/or streams, such as web pages, photographs, and videos, over the wireless network 212, gateway 216, and wide area network 214 (e.g., using TCP/IP or UDP protocols). Likewise, the mobile device 100b can place and receive phone calls, send and receive e-mail messages, and retrieve electronic documents over the access point 218 and the wide area network 214. In some implementations, the mobile device 100 can be physically connected to the access point 218 using one or more cables and the access point 218 can be a personal computer. In this configuration, the mobile device 100 can be referred to as a “tethered” device.

The mobile devices 100a and 100b can also establish communications by other means. For example, the wireless device 100a can communicate with other wireless devices, e.g., other wireless devices 100, cell phones, etc., over the wireless network 212. Likewise, the mobile devices 100a and 100b can establish peer-to-peer communications 220, e.g., a personal area network, by use of one or more communication subsystems, such as the Bluetooth™ communication device 188 shown in FIG. 1. Other communication protocols and topologies can also be implemented.

The mobile device 100 can, for example, communicate with one or more services 230, 240, 250, 255, and 260 and/or one or more content publishers 270 over the one or more wired and/or wireless networks 210. For example, a navigation service 230 can provide navigation information, e.g., map information, location information, route information, and other information, to the mobile device 100. In the example shown, a user of the mobile device 100b has invoked a map functionality, e.g., by touching the maps object 144 on the top-level graphical user interface shown in FIG. 1, and has requested and received a map for the location “1 Infinite Loop, Cupertino, Calif.”

A messaging service 240 can, for example, provide e-mail and/or other messaging services. A media service 250 can, for example, provide access to media files, such as song files, movie files, video clips, and other media data. A location-based service 255 can, for example, provide data or content based on a current location of the mobile device 100. One or more other services 260 can also be utilized by the mobile device 100, including a syncing service, an activation service and a software update service that automatically determines whether software updates are available for software on the mobile device 100, then downloads the software updates to the mobile device 100 where the updates can be manually or automatically unpacked and/or installed.

The mobile device 100 can also access other data over the one or more wired and/or wireless networks 210. For example, content publishers 270, such as news sites, RSS feeds, web sites, blogs, social networking sites, developer networks, etc., can be accessed by the mobile device 100. Such access can be provided by invocation of a web browsing function or application (e.g., a browser) in response to a user touching the Web object 114.

### Exemplary Display of Applications

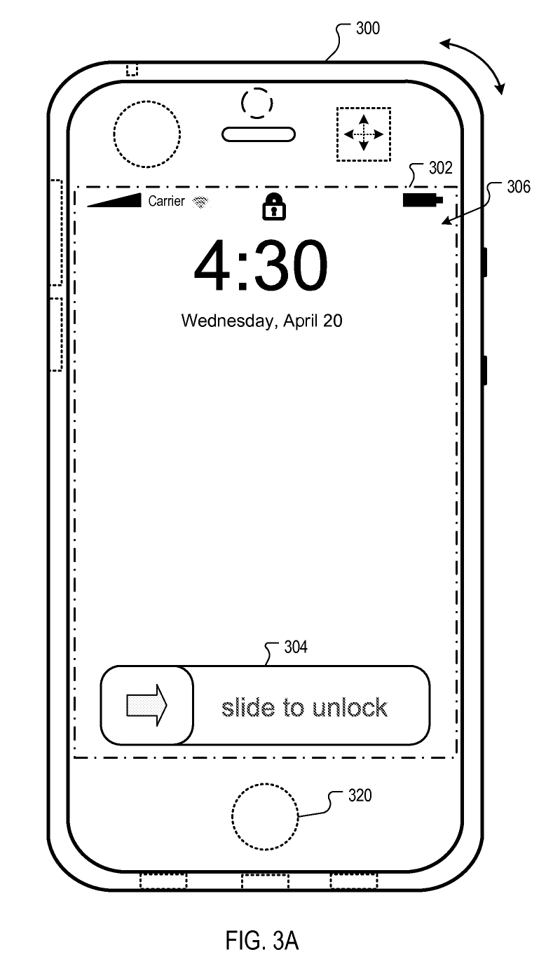

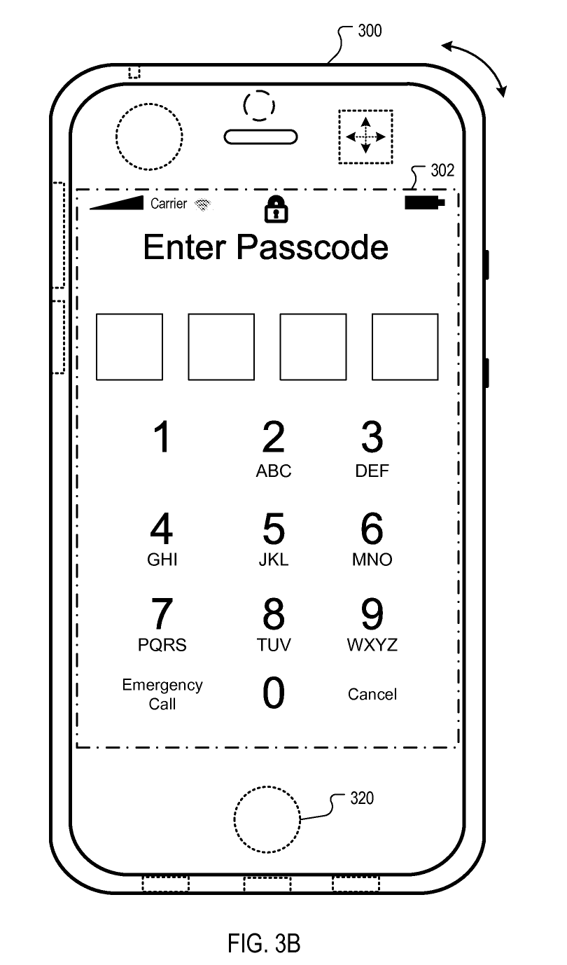

FIGS. 3A-3B depict example displays of enforcing a security wall on a computing device. Computing devices generally can be configured to implement a security wall to restrict unwanted or accidental access to functionality provided by the computing devices. FIG. 3A illustrates implementation of an example security measure for restricting access to applications on a mobile device 300. The mobile device 300 can enter a “stand-by” or “locked” mode as depicted in FIG. 3A. In a stand-by mode, mobile device 300 can enforce a security wall to prohibit access to functionality, applications, and information usually provided by the mobile device 300. In some instances, limited features can be presented during a stand-by mode of the mobile device 300, such as a current time and date, an indicator of remaining battery life, or a cellular reception signal strength. The remaining functionality provided by mobile device 300, however, can be restricted until a security input is received by the mobile device 300.

Mobile device 300 can require different security inputs before a user is given access to functionality of the mobile device 300. In FIG. 3A, a sliding motion performed by a user in contact with the touch-sensitive display 302 can trigger unlocking of the mobile device 300. For example, the user may perform a sliding motion in a particular direction on a certain slider region 304 of the touch-sensitive display 302 to unlock the mobile device 300. In general, the requiring of the sliding motion input prevents accidental unlocking of the mobile device 300. A different input can also be required to unlock the mobile device 300, such as entering a security code on the touch-sensitive display 302, as depicted in FIG. 3B. As seen in FIG. 3B, a screen for entering the security code is presented on the touch-sensitive display 302 before a user is allowed to unlock and access applications on the mobile device 300. This prevents users who do not have permission to access applications on the mobile device 300 from gaining access to applications.

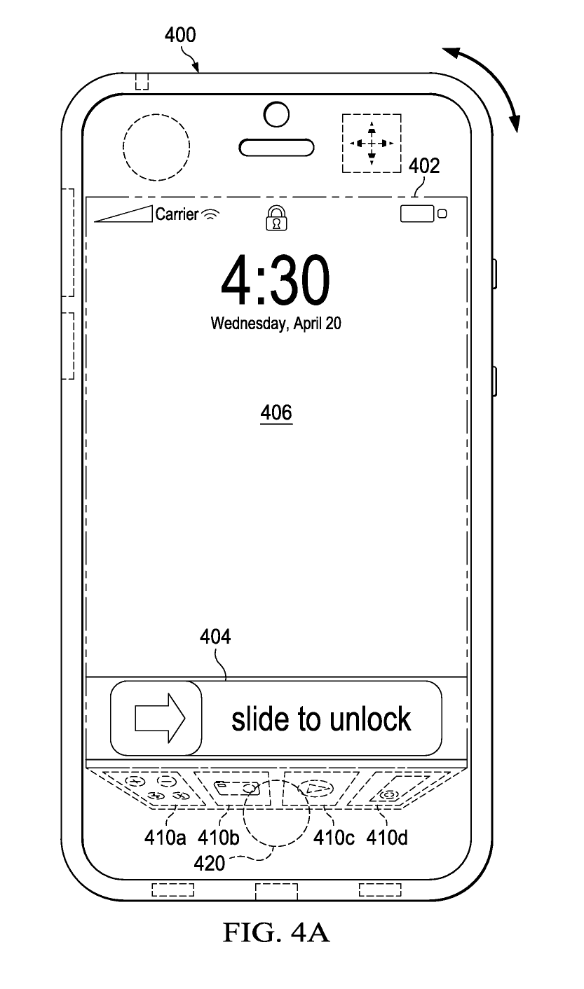

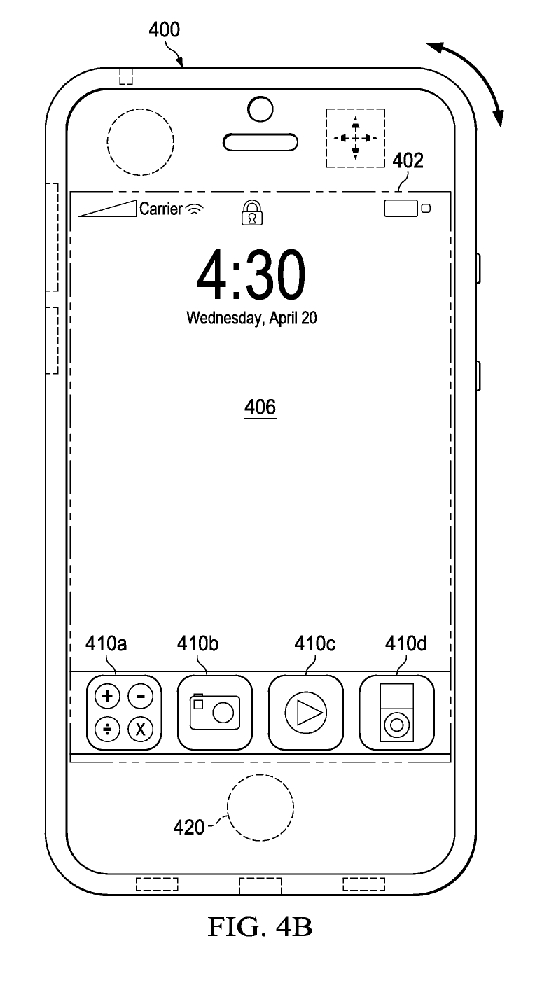

In some instances, the home button on a mobile device is used to allow immediate or quick access to certain applications on the mobile device without input of a security code. FIGS. 4A-4B illustrate example displays of quickly accessing certain applications on a mobile device 400 through a home button 420 on the mobile device 400. Initially, a slider region 404 is present on the touch-sensitive display 402 to require a sliding motion input for preventing accidental unlocking of the mobile device 400. A user may perform a sliding motion in the slider region 404 to unlock the mobile device 400 or to bring up a security screen, similar to FIG. 3B, for inputting a security code. Alternatively, the user may bypass the sliding input or security screen by entering a predefined input using the home button 420 to enter a “quick access” mode of the mobile device 400 in which certain applications may be immediately available to the user, regardless of whether a security wall may be enforced with respect to applications on the mobile device 400. In some implementations, for example, touching the home button 420 may trigger an animation to transition visual objects 410 onto the touch-sensitive display 102. Each of the visual objects may represent an application available to the user without entering the sliding motion in the slider region 404 or a security code. As seen in FIG. 4A, the visual objects 410 may initially be hidden from view. As the visual objects 410 are transitioned onto the touch-sensitive display 402, they may appear from below the slider region 404 as if they are initially located just below the visible area of the touch-sensitive display 402, as seen in FIG. 4A. As the objects 410 move up onto the display 402, the slider region 404 may be compressed during the animation until the slider region 404 is removed from view, as illustrated in FIG. 4B. The “quick access” mode may be available to a user of the mobile device 400 after the mobile device 400 has completed a boot sequence.

The applications that are available to the user through the “quick access” mode may include applications that do not reveal private information or applications that a user may need to quickly access. Such applications may include, for example, a calculator application 410a, a camera application 410b, a remote controller for multimedia player application 410, a media player application 410d, or a voice control application. Other applications may be available through the “quick access” mode of the mobile device 400. In some instances, for example, a user may designate the applications that are available in the “quick access” mode of the mobile device 400. Further, in some implementations, only a portion of an application may be available through the “quick access” mode while a remaining portion of the application is blocked from access until a security code is entered. For example, a user may access a camera application 410b using the predefined input at the home button 420 while the mobile device 400 is still locked. The user may take new pictures using the camera application 410b but may be prevented from viewing pictures previously taken using the camera application 410b until the user enters a security code to bypass the security wall.

In certain implementations, the predefined input may include two parts, with a first part comprising the user initiating and maintaining contact with the home button 420, and the second part comprising the user subsequently inputting one or more gesture motions, such as flicking or moving a finger in contact with the home button 420 in a particular direction as the finger moves off the touch-sensitive display 402. In other instances, the predefined input may include two parts comprising a first upward motion of a user in contact with the home button 420 and a second upward motion of the user in contact with the home button 420 within a particular amount of time. In certain implementations, a preview of the visual objects 410 appears immediately or after a certain amount of time in response to a user maintaining contact with the home button 420 without completing the second part of the predefined input. The preview of the visual objects 410 may appear after the minimum amount of time, and the user may perform the second part of the predefined input to bring the visual objects 410 fully into view, as illustrated in FIG. 4B. As depicted in FIG. 4B, the user may enter a quick access phase, after finishing the predefined input, in which the slider region 404 is removed and the visual objects 410a, 410b, 410c, and 410d are fully displayed. The user may then select one or more of the objects 410 to access the application represented by the object.

As seen in FIG. 4B, the slider region 404 from FIG. 4A may be removed from view when the visual objects 410 are fully displayed in the touch-sensitive display 402. In some implementations, the display of visual objects 410 in response to the predefined input may immediately transition the mobile device 400 out of a sleep mode into a wakeup mode. For example, in a sleep mode, the mobile device 400 may turn off the back-light for the touch-sensitive display 402 of the mobile device 400. To wake up the mobile device 400 from sleep mode may typically require receiving an input from a tactile button of the mobile device 400 before additional actions, such as unlocking the mobile device 400, may be performed. The receiving of the predefined input using the home button 420 may automatically wake up the mobile device 400 from sleep mode while simultaneously displaying a set of application objects 410 for quick access without an additional unlocking action (e.g., using the slider region 404). Accordingly, instead of requiring a button input from a tactile button on the mobile device 400 and then a sliding motion along the slider region 404, the mobile device 400 may be transitioned into a wakeup mode through receiving the predefined input at the home button 420, giving the user immediate access to certain applications. Further, although FIGS. 4A-4B illustrate the availability of certain applications through a predefined input at the home button 420 while the mobile device 400 is locked, the applications may be quickly accessed through the home button 420 when the mobile device 400 is unlocked, in some implementations. For example, after a user has entered a security code to access all the applications on the mobile device 400, the user may enter the predefined input at the home button 420 at any time to bring up the four objects 410a, 410b, 410c, and 410d.

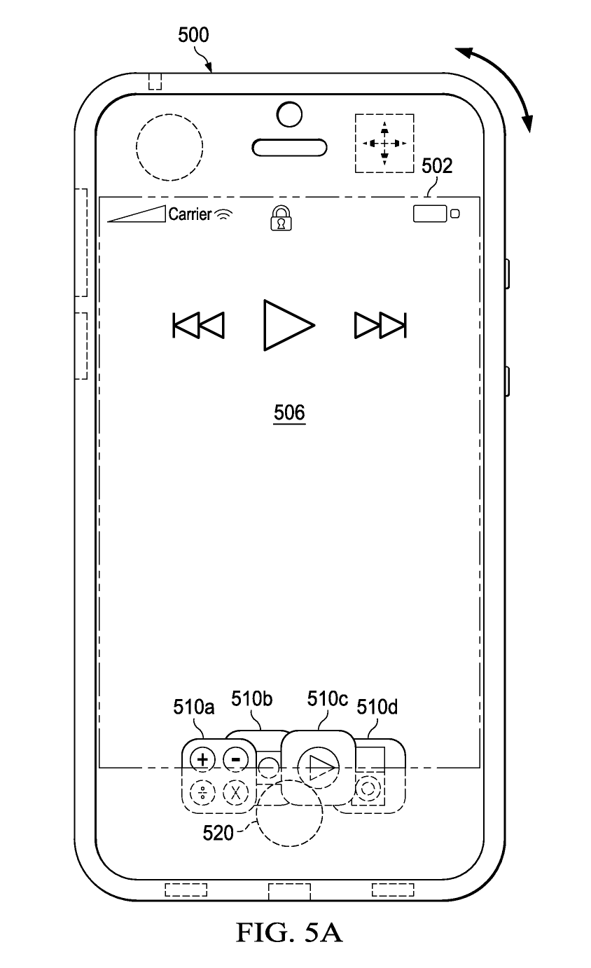

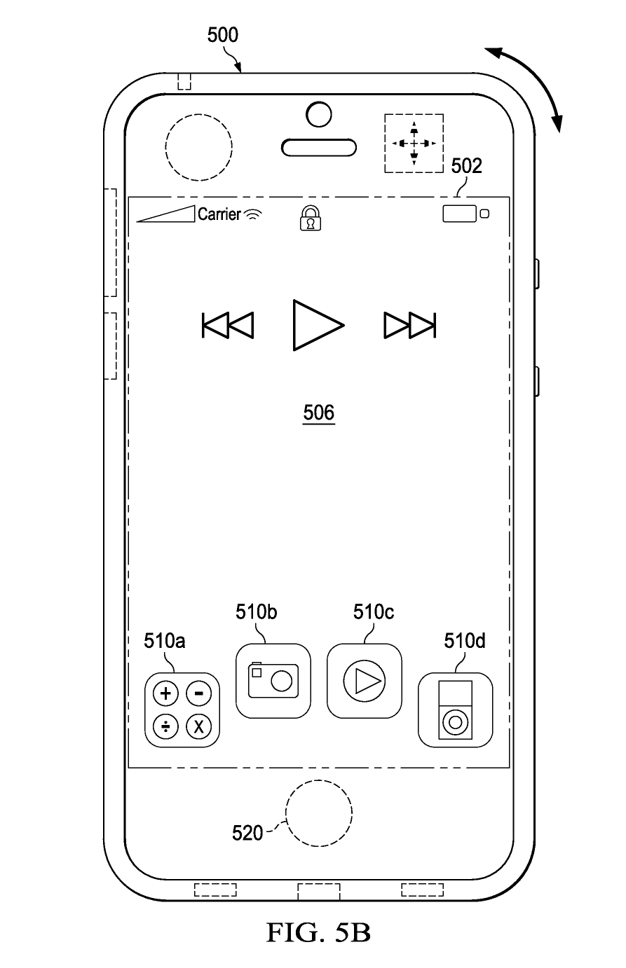

FIGS. 5A-5B illustrate another example of quickly accessing certain applications on a mobile device 500 through a home button 520 on the mobile device 500. A user may initiate access to a set of applications 510 by entering a first part of a predefined input, such as initiating contact with a home button 520. As seen in FIG. 5A, the application objects 510a, 510b, 510c, and 510d are initially clustered in a group around the home button 520 region after the user enters a first part of the predefined input on the home button 520. The user may complete the predefined input by entering the second part of the input, and in response, the cluster of application objects 510 are expanded outward in a semi-circle pattern surrounding the home button, as illustrated in FIG. 5B. In some instances, if the user does not complete the predefined input, such as by withdrawing contact with the home button 520, for example, the cluster of application objects 510 may retract back into the region where the objects originated and disappear from view. When the application objects 510 are expanded as in FIG. 5B, the user may select one of the objects to execute the application during “quick access” mode.

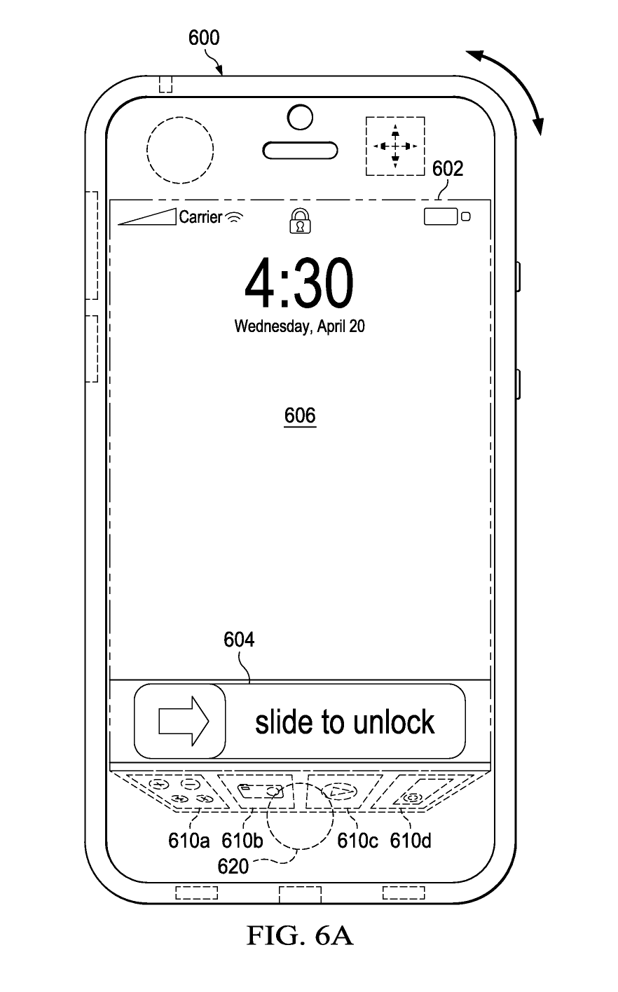

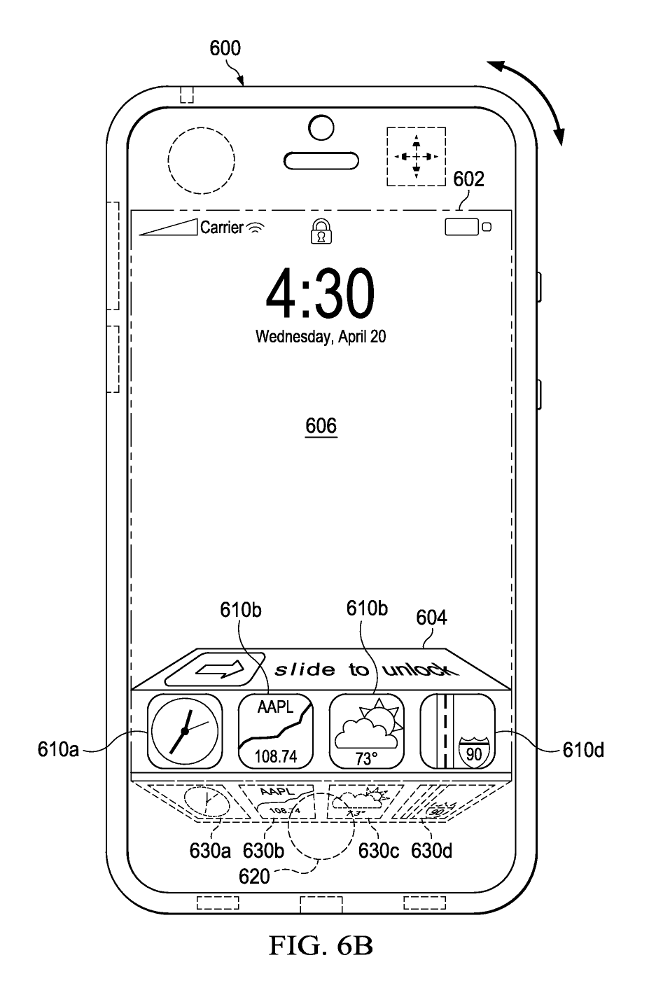

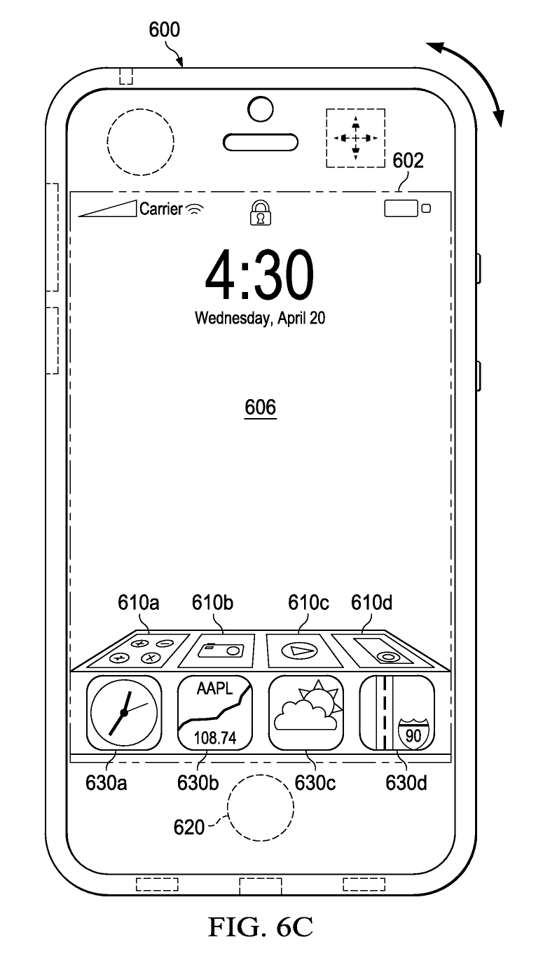

FIGS. 6A-6C illustrate another example of quickly accessing certain applications on a mobile device 600 through a home button 620 on the mobile device 600. In some implementations, certain inputs associated with the home button 620 may trigger display of application objects 610 through a particular animation for easy display. For example, as seen in FIG. 6A, a user may touch the home button 620 to trigger the animation for bringing up application objects 610 available through the “quick access” mode of the mobile device 600. In the illustrated example in FIG. 6A, the application objects 610 may be “hidden” from view just below the visible area of the touch-sensitive display 602. If the user continues with a predefined input on the home button 620, as described above in relation to FIGS. 4A-4B, the application objects 610 may appear on the touch-sensitive display 602 as full icons 610, becoming available for selection by the user, as seen in FIG. 6B. Further, the animation of the application objects 610 appearing on the display 602 may also compress the slider region 604 right above the application objects 610, as depicted in FIG. 6B.

In some implementations, the expansion of the application objects 610 and compression of the slider region 604 may be animated as a rotation of an imaginary three-dimensional polygonal object about an axis that is perpendicular to the length of the mobile device 600 and within the same plane as the mobile device 600, where the sides of the three-dimensional object contains the slider region 604 on one face and the application objects 610 on another face. In FIG. 6B, the side with the application objects 610 has “rotated” forward facing a viewer of the touch-sensitive display 602 while the slider region 604 has “rotated” upward and away from the viewer. The imaginary three-dimensional polygonal object may contain additional “sides” that contain additional objects. As illustrated in FIG. 6C, for example, a user may enter another specific input using the home button 620 to rotate the first set of application objects 610 away while rotating in another set of application objects 630.

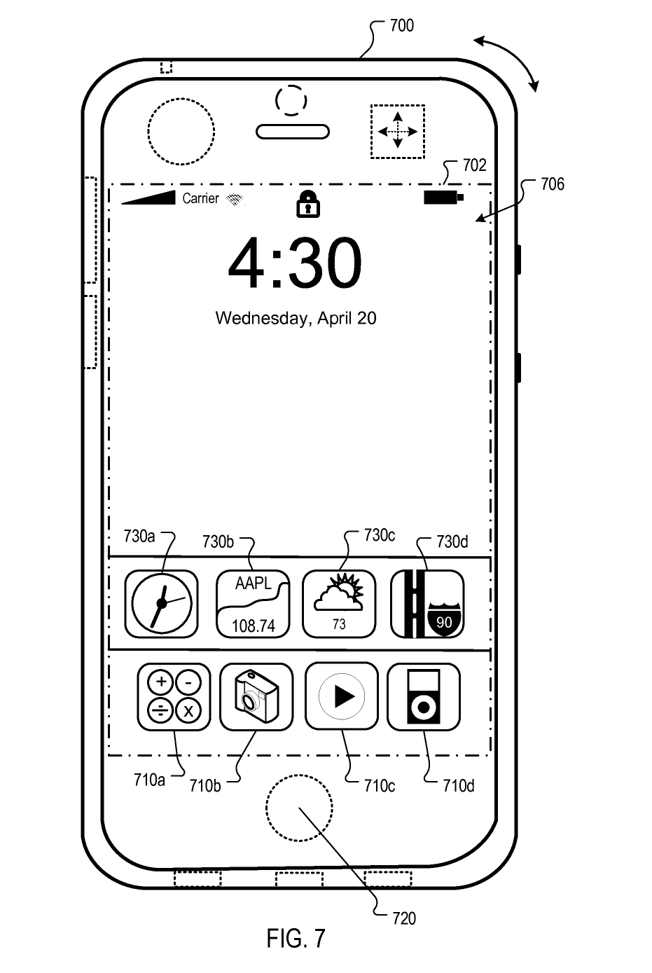

Other implementations for allowing quick access to applications through certain inputs with a home button may also be used. As seen in FIG. 7, for example, multiple rows of application objects 710 and 730 may be displayed concurrently using the home button 720. A user may enter the predefined input a first time using the home button 720 to bring up a first row of application objects 730, similar to the illustration in FIG. 4B. The user may bring up a second row of application objects 710 by entering the same predefined input a second time using the home button 720. The animation of the process may slide the first row of application objects 730 up while the second row of application objects 710 up underneath the first row. Similarly, additional rows of application objects may be displayed using a similar input on the home button 720. In some implementations, different inputs using the home button 720 may correspond to different actions. For example, if the mobile device 700 is in a sleep mode, a certain input using the home button 720 may automatically wake the mobile device 700 from sleep mode and bring up the security screen for security code entry, similar to the illustration in FIG. 3B.

### Exemplary Processes for Providing Quick Access to Applications

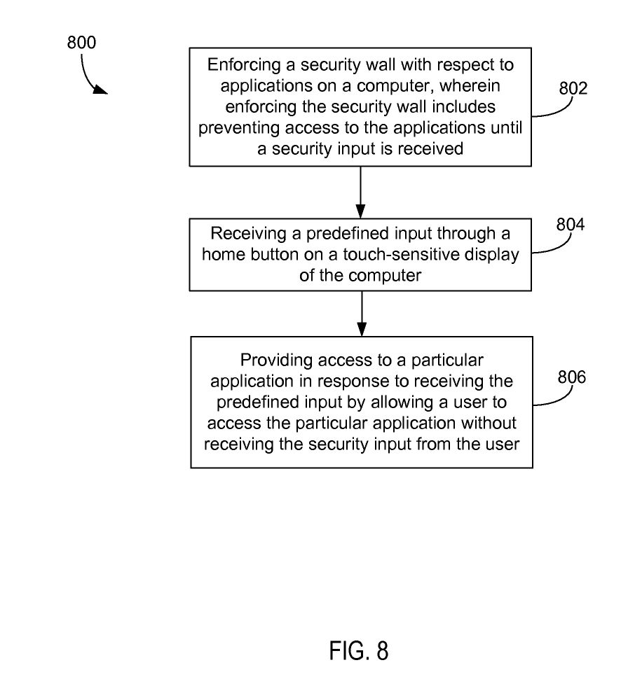

FIG. 8 is a flow diagram of an exemplary process 800 for designating and displaying public and private applications. In the exemplary process 800, a security wall is enforced with respect to applications on a computer, wherein enforcing the security wall includes preventing access to the applications until a security input is received (802). A predefined input is received through a home button on a touch-sensitive display of the computer (804). Access to a particular application is provided in response to receiving the predefined input by allowing a user to access the particular application without receiving the security input from the user (806).

The above processes are merely examples. Various combinations of the above processes are possible.

### Exemplary Device Architecture

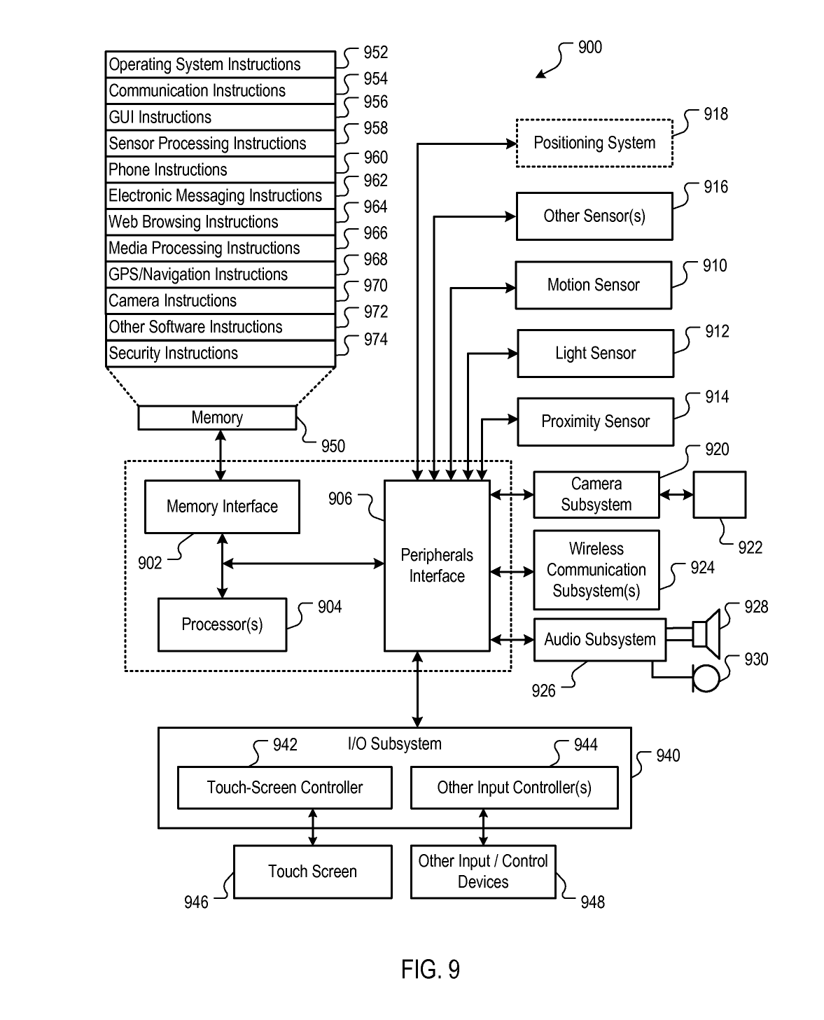

FIG. 9 is a block diagram 900 of an example implementation of the mobile device 100 of FIG. 1. The mobile device 100 can include a memory interface 902 one or more data processors, image processors and/or central processing units 904, and a peripherals interface 906. The memory interface 902, the one or more processors 904 and/or the peripherals interface 906 can be separate components or can be integrated in one or more integrated circuits. The various components in the mobile device 100 can be coupled by one or more communication buses or signal lines.

Sensors, devices and subsystems can be coupled to the peripherals interface 906 to facilitate multiple functionalities. For example, a motion sensor 910, a light sensor 912, and a proximity sensor 914 can be coupled to the peripherals interface 906 to facilitate the orientation, lighting and proximity functions described with respect to FIG. 1. Other sensors 916 can also be connected to the peripherals interface 906, such as a GPS receiver, a temperature sensor, a biometric sensor, or other sensing device, to facilitate related functionalities.

A camera subsystem 920 and an optical sensor 922, e.g., a charged coupled device (CCD) or a complementary metal-oxide semiconductor (CMOS) optical sensor, can be utilized to facilitate camera functions, such as recording photographs and video clips.

Communication functions can be facilitated through one or more wireless communication subsystems 924, which can include radio frequency receivers and transmitters and/or optical (e.g., infrared) receivers and transmitters. The specific design and implementation of the communication subsystem 924 can depend on the communication network(s) over which the mobile device 100 is intended to operate. For example, a mobile device 100 may include communication subsystems 924 designed to operate over a GSM network, a GPRS network, an EDGE network, a 3G or 4G network, a Wi-Fi or WiMax network, and a Bluetooth™ network. In particular, the wireless communication subsystems 924 may include hosting protocols such that the device 100 may be configured as a base station for other wireless devices.

An audio subsystem 926 can be coupled to a speaker 928 and a microphone 930 to facilitate voice-enabled functions, such as voice recognition, voice replication, digital recording, and telephony functions.

The I/O subsystem 940 can include a touch screen controller 942 and/or other input controller(s) 944. The touch-screen controller 942 can be coupled to a touch screen 946. The touch screen 946 and touch screen controller 942 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 946.

The other input controller(s) 944 can be coupled to other input/control devices 948, such as one or more buttons, rocker switches, thumb-wheel, infrared port, USB port, and/or a pointer device such as a stylus. The one or more buttons (not shown) can include an up/down button for volume control of the speaker 928 and/or the microphone 930.

In one implementation, a pressing of the button for a first duration may disengage a lock of the touch screen 946; and a pressing of the button for a second duration that is longer than the first duration may turn power to the mobile device 100 on or off. The user may be able to customize a functionality of one or more of the buttons. The touch screen 946 can, for example, also be used to implement virtual or soft buttons and/or a keyboard.

In some implementations, the mobile device 100 can present recorded audio and/or video files, such as MP3, AAC, and MPEG files. In some implementations, the mobile device 100 can include the functionality of an MP3 player, such as an iPod™. The mobile device 100 may, therefore, include a 36-pin connector that is compatible with the iPod. Other input/output and control devices can also be used.

The memory interface 902 can be coupled to memory 950. The memory 950 can include high-speed random access memory and/or non-volatile memory, such as one or more magnetic disk storage devices, one or more optical storage devices, and/or flash memory (e.g., NAND, NOR). The memory 950 can store an operating system 952, such as Darwin, RTXC, LINUX, UNIX, OS X, WINDOWS, or an embedded operating system such as VxWorks. The operating system 952 may include instructions for handling basic system services and for performing hardware dependent tasks. In some implementations, the operating system 952 handles timekeeping tasks, including maintaining the date and time (e.g., a clock) on the mobile device 100. In some implementations, the operating system 952 can be a kernel (e.g., UNIX kernel).

The memory 950 may also store communication instructions 954 to facilitate communicating with one or more additional devices, one or more computers and/or one or more servers. The memory 950 may include graphical user interface instructions 956 to facilitate graphic user interface processing; sensor processing instructions 958 to facilitate sensor-related processing and functions; phone instructions 960 to facilitate phone-related processes and functions; electronic messaging instructions 962 to facilitate electronic-messaging related processes and functions; web browsing instructions 964 to facilitate web browsing-related processes and functions; media processing instructions 966 to facilitate media processing-related processes and functions; GPS/Navigation instructions 968 to facilitate GPS and navigation-related processes and instructions; camera instructions 970 to facilitate camera-related processes and functions; other software instructions 972 to facilitate other related processes and functions; and/or security instructions 974, together with graphical user interface instructions 956, to implement the features and processes of FIGS. 1-8.

The memory 950 can also store data, including but not limited to documents, images, video files, audio files, and other data.

In some implementations, the mobile device 100 includes a positioning system 918. In various implementations, the positioning system 918 can be provided by a separate device coupled to the mobile device 100, or can be provided internal to the mobile device. In some implementations, the positioning system 918 can employ positioning technology including a GPS, a cellular grid, URIs or any other technology for determining the geographic location of a device. In some implementations, the positioning system 918 can employ a service provided by a positioning service such as, for example, SkyHook Wireless of Boston, Mass., or Rosum Corporation of Mountain View, Calif. In other implementations, the positioning system 918 can be provided by an accelerometer and a compass using dead reckoning techniques. In such implementations, the user can occasionally reset the positioning system by marking the mobile device's presence at a known location (e.g., a landmark or intersection). In still other implementations, the user can enter a set of position coordinates (e.g., latitude, longitude) for the mobile device. For example, the position coordinates can be typed into the phone (e.g., using a virtual keyboard) or selected by touching a point on a map. Position coordinates can also be acquired from another device (e.g., a car navigation system) by syncing or linking with the other device. In other implementations, the positioning system 918 can be provided by using wireless signal strength and one or more locations of known wireless signal sources to provide the current location. Wireless signal sources can include access points and/or cellular towers. Other techniques to determine a current location of the mobile device 100 can be used and other configurations of the positioning system 918 are possible.

Each of the above identified instructions and applications can correspond to a set of instructions for performing one or more functions described above. These instructions need not be implemented as separate software programs, procedures or modules. The memory 950 can include additional instructions or fewer instructions. Furthermore, various functions of the mobile device 100 may be implemented in hardware and/or in software, including in one or more signal processing and/or application specific integrated circuits.

The disclosed and other embodiments and the functional operations described in this specification can be implemented in digital electronic circuitry, or in computer software, firmware, or hardware, including the structures disclosed in this specification and their structural equivalents, or in combinations of one or more of them. The disclosed and other embodiments can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the disclosed embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The disclosed embodiments can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments have been described. Other embodiments are within the scope of the following claims.

What is claimed is:

1. A method performed by one or more processors executing on a computer, the method comprising:
enforcing a security wall with respect to applications on the computer, wherein enforcing the security wall includes preventing access to the applications until a security input is received;
receiving a predefined input through a home button on a touch-sensitive display of the computer; and
providing access to a particular application in response to receiving the predefined input, wherein providing access to the particular application includes allowing a user to access the particular application without receiving the security input from the user.

2. The method of claim 1 wherein the home button includes a portion of the touch-sensitive display having both touch-sensitive and pressure-sensitive properties.

3. The method of claim 1 further comprising:
receiving a second instance of the predefined input through the home button; and
providing access to a second application concurrently with providing access to the particular application, wherein providing access to the second application includes allowing a user to access the second application without receiving the security input from the user.

4. The method of claim 1 wherein the predefined input includes a first upward motion of a user in contact with the home button and a second upward motion of the user in contact with the home button within a particular amount of time.

5. The method of claim 1 wherein providing access to the particular application includes generating for display a visual object representing the particular application on the touch-sensitive display, wherein the visual object is displayed concurrently with a second visual object for bypassing the security wall.

6. The method of claim 1 wherein providing access to the particular application includes allowing the user to access a first portion of the particular application while the security wall is enforced with respect to a remaining portion of the particular application.

7. The method of claim 1 wherein the particular application includes at least one of a camera application, a remote controller for multimedia player application, a calculator application, a media player application, or a voice control application.

8. The method of claim 1 further comprising receiving a second predefined input through the home button and presenting a login page for traversing the security wall.

9. The method of claim 1 wherein enforcing the security wall occurs after the computer has concluded a full boot sequence.

10. The method of claim 1 further comprising automatically waking the computer from a sleep mode in response to receiving the predefined input.

11. A computer program product tangibly embodied in a computer-readable storage medium, the computer program product including instructions that, when executed, perform the following operations:
enforcing a security wall with respect to applications on the computer, wherein enforcing the security wall includes preventing access to the applications until a security input is received;
receiving a predefined input through a home button on the computer having multi-touch sensitivity; and
providing access to a particular application in response to receiving the predefined input, wherein providing access to the particular application includes allowing a user to access the particular application without receiving the security input from the user.

12. The computer program product of claim 11 wherein the home button includes a region of a touch screen of the computer having multi-touch sensitivity, the region of the touch screen separate from a touch-sensitive display of the computer.

13. The computer program product of claim 11 wherein providing access to the particular application includes generating for display a visual object representing the particular application on the touch-sensitive display and hiding a second visual object for bypassing the security wall.

14. The computer program product of claim 11 wherein providing access to the particular application includes allowing the user to access a first portion of the particular application while the security wall is enforced with respect to a remaining portion of the particular application.

15. The computer program product of claim 11 wherein the particular application includes at least one of a camera application, a remote controller for multimedia player application, a calculator application, a media player application, or a voice control application.

16. The computer program product of claim 11 wherein the operations further include automatically waking the computer from a sleep mode in response to receiving the predefined input.

17. A system comprising:
a computer-readable storage medium operable to store instructions of an application;
a user interface module operable to enforce a security wall with respect to applications on a computing device, wherein enforcing the security wall includes preventing access to the applications until a security input is received, the user interface module further operable to receive a predefined input through a home button on the computing device having multi-touch sensitivity and provide access to a particular application in response to receiving the predefined input, wherein providing access to the particular application includes allowing a user to access the particular application without receiving the security input from the user.

18. The system of claim 17 wherein the home button includes a region of a touch screen of the computing device having multi-touch sensitivity, the region of the touch screen separate from a touch-sensitive display of the computing device.

19. The system of claim 17 wherein the particular application includes at least one of a camera application, a remote controller for multimedia player application, a calculator application, a media player application, or a voice control application.

20. The system of claim 17 wherein the user interface module is further operable to receive a second predefined input through the home button and present a login page for traversing the security wall in response to receiving the second predefined input.
